(19) United States
(12) Patent Application Publication
(10) Pub. No.: US 2009/0197222 A1
(43) Pub. Date: Aug. 6, 2009

(54) Ball rolling unit

(76) Inventor: Shih-Hwa Yuan, Shulin City (TW)

Correspondence Address: PRO-TECHTOR INTERNATIONAL SERVICES, 20775 NORADA CT., SARATOGA, CA, 95070, US

(21) Appl. No.: 12/069,149

(22) Filed: Feb. 6, 2008

(51) Int. Cl. G09B 19/00

(52) U.S. Cl. 434/128

(57) ABSTRACT

A ball rolling unit for fun to initiate vision and hand coordination for pre-school children includes multiple canopies, a section of course extending downward at a certain inclination being sewn to each canopy; an inner peripheral of each course and its corresponding sides being sewn with hooks and loops of a Velcro to open or close each course; and a ball rolling upon the ball rolling unit for pre-school children standing around the ball rolling unit to roll the ball thereon by holding an edge of the ball rolling unit to pull it up and down for learning to focus on movement of an object and agile reaction of their hands in various forms of the game with each channel opened, closed, or formed into a pocket.

### BACKGROUND OF THE INVENTION

1. Field of the Invention

The present invention is related to a ball rolling unit, and more particularly, to one that is fun for initiating vision and hand coordination of pre-schooling children.

2. Description of the Prior Art

Games generally designed for pre-school children while taking how to attract attention from the children into consideration must provide functions of initiating agility of limbs and intellectual development of the children. There are many fun and educational equipments developed in this regard and one involves having multiple placement and dummy cavities arranged in different diameters and at random on a single unit for pre-school children to roll a ball. However, each of those placement cavities for throwing is related to a vertical pocket, the child attempting to throw the ball falling into the cavity out of the cavity must throw the ball at a vertical angle, meaning the child has to exert a lot of efforts to throw the ball in a state of reciprocal jumping status out of the pocket so to continue to play the game of rolling the ball on the unit. Furthermore, the vertical pocket of the placement cavity fails to make selective close or allow printing preset pattern and symbol among the placement cavities. Accordingly the ball rolling unit of the prior art though disposed with multiple placement cavities and dummy cavities arranged in different diameters and at random provides only a single type of game.

### SUMMARY OF THE INVENTION

The present invention is related to a ball rolling unit of fun based on the prior art that is capable of initiating coordination between vision and hand of pre-school children by having the children to roll the ball in various forms of game to roll the ball on one or a plurality of course, which allows to be opened or closed, disposed on a peripheral of the ball rolling unit. Pre-school children may practice focusing on movement of an object and agile reaction from hand in playing the game of rolling the ball.

The primary purpose of the present invention is to provide a ball rolling unit having a ball rolling thereon for children standing around the ball rolling unit to move it up and down for rolling the ball into a course in a preset direction. Children while attempting to roll the ball into the course have the fun of multiple variations produced in the game and learn how to concentrate on movement of an object and agile reaction of their hands. To achieve the purpose, the ball rolling unit is comprised of multiple canopies and a section of course extending downward at a certain inclination is sewn onto each canopy; and hooks and loops of a Velcro are sewn to an inner peripheral and its corresponding sides of the course to form multiple course surrounding the ball rolling unit that may be opened or closed with the Velcro.

Another purpose of the present invention is to provide a ball rolling unit disposed with multiple courses sewn to an inner peripheral of the ball rolling unit that are closed with the hooks and loops of the Velcro for children standing around the ball rolling unit to roll the ball in any direction as desired on the ball rolling unit by pulling up and down the ball rolling unit.

A third purpose of the present invention is to provide a ball rolling unit disposed with multiple courses each sewn to the ball rolling unit with hooks and loops of the Velcro. All courses are opened up and the ball is caught in a through hole formed by having those hooks and loops partially locked to one another; and children standing around the ball rolling unit try to throw the ball out of the through hole in a preset direction by pulling the ball rolling unit up and down.

A fourth purpose of the present invention is to provide a ball rolling unit disposed with multiple courses thereon with each course having its inner peripheral sewn with hooks and loops of the Velcro. The Velcro is closed to form a pocket for children standing around the ball rolling unit to try rolling the ball into any pocket.

### BRIEF DESCRIPTION OF THE DRAWINGS

FIG. 1 is a schematic view showing a section of course extending downward at a certain inclination sewn to each canopy of a ball rolling unit of a preferred embodiment of the present invention.

FIG. 2 is a schematic view showing details of a Velcro is sewn to corresponding sides of a peripheral of the course taken from FIG. 1.

FIG. 3 is a schematic view showing that the course taken from FIG. 2 is closed up by the Velcro.

FIG. 3-1 is a schematic view showing a ball is rolling on the rolling unit with its course taken form FIG. 3 being closed.

FIG. 4 is a schematic view showing that both sides of the course taken from FIG. 2 are partially locked to form a through hole for throwing the ball out of the through hole.

FIG. 4-1 is a schematic view showing the ball is thrown out of the course taken form FIG. 4 in its open status on the ball rolling unit.

FIG. 5 is a-perspective view showing the course taken from FIG. 4 is in its open status.

FIG. 5-1 is a schematic view showing that the ball is thrown out on the ball rolling unit with its course taken from FIG. 5 indicating open status.

FIG. 6 is a schematic view showing a pocket is formed by closing up the Velcro disposed on the peripheral of the course taken from FIG. 2.

FIG. 7 is a perspective view showing the pocket taken from FIG. 6.

FIG. 7-1 is a schematic view showing the ball rolling unit in a pocket shape taken from FIG. 6 for the ball to roll into the pocket.

FIG. 8 is a perspective view of the ball rolling unit.

FIG. 9 is a schematic view showing that the ball rolling unit of the present invention is provided as a game for children to play with.

### DETAILED DESCRIPTION OF THE PREFERRED EMBODIMENTS

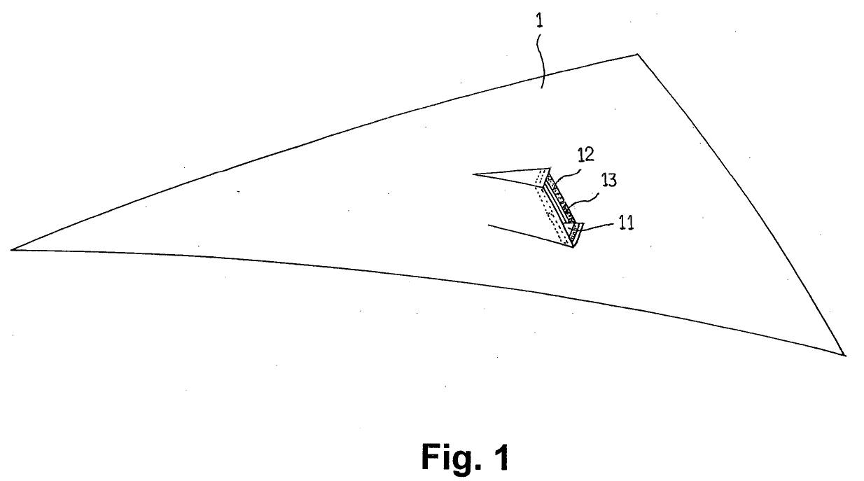

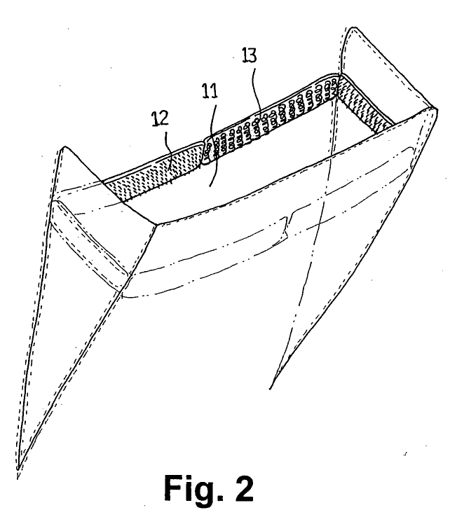

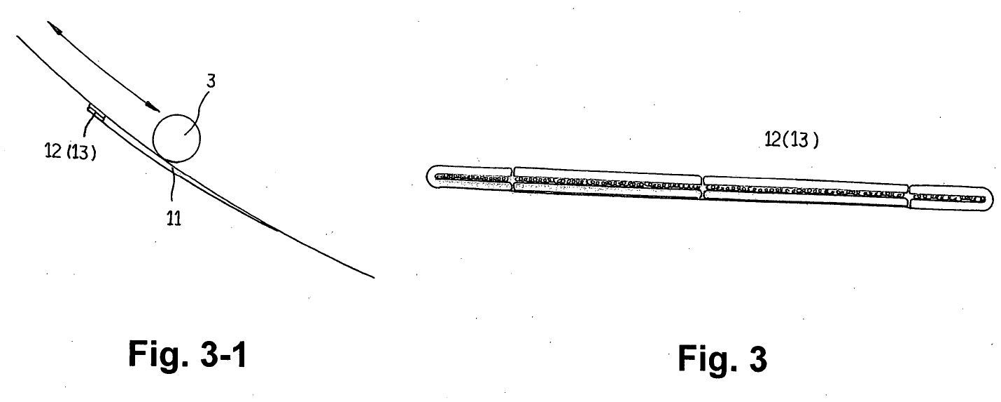

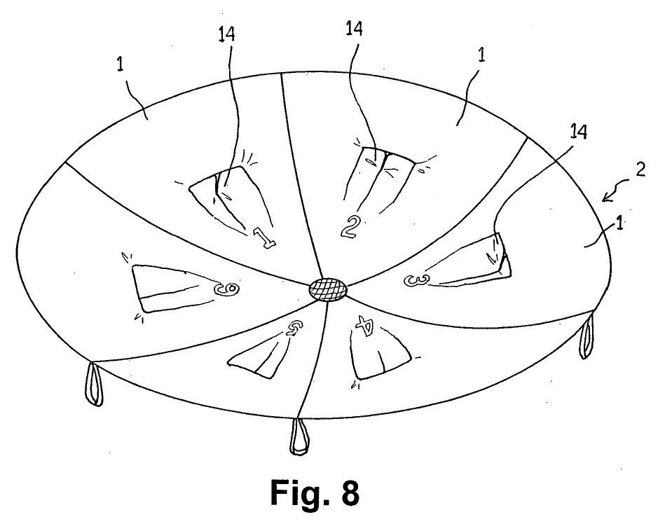

Referring to FIGS. 1 and 8, a ball rolling unit (2) for fun to initiate vision and hand coordination of pre-school children of the present invention is essentially comprised of multiple canopies (1) and a ball (3) to roll thereon. Wherein, a section of course (11) extending downward at a certain inclination is sewn to each canopy (1); an inner peripheral of the course (11) and its corresponding sides are sewn with multiple hooks (12) and loops (13) of a Velcro as illustrated in FIG. 2. Multiple courses (11) allow be opened (as illustrated in FIG. 2) or closed (as illustrated in FIG. 3) with those hooks (12) and loops (13) of the Velcro.

The ball rolling unit (2) permits multiple ways for children to play with. As illustrated in FIG. 3, in a first preferred embodiment of the present invention, multiple courses (11) are closed with those hooks (12) and loops (13) of the Velcro for the ball rolling unit (2) to indicate a concave shape; children standing around the ball rolling unit (2) roll the ball (3) thereon in any direction as illustrated in FIG. 3-1 by pulling up and down the ball rolling unit (2) by holding its edge for those pre-school children to practice focusing on movement of an object and agile reaction of hands while rolling the ball (3).

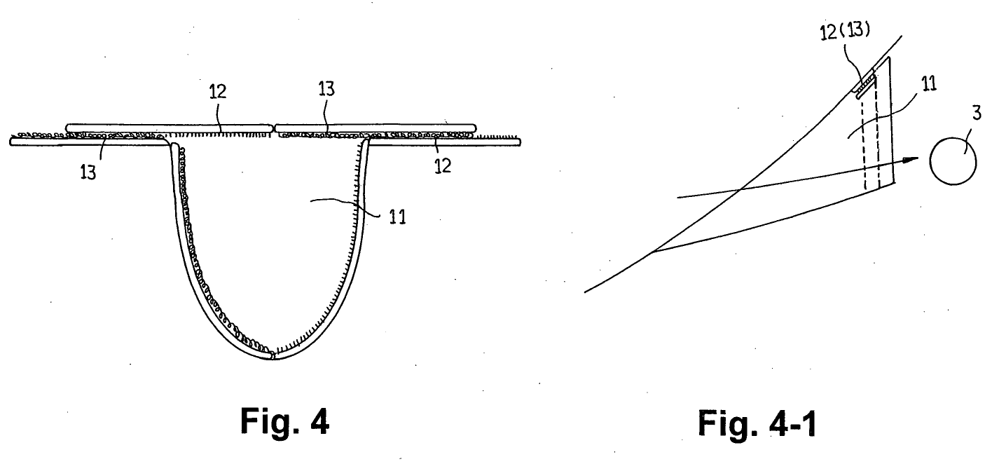

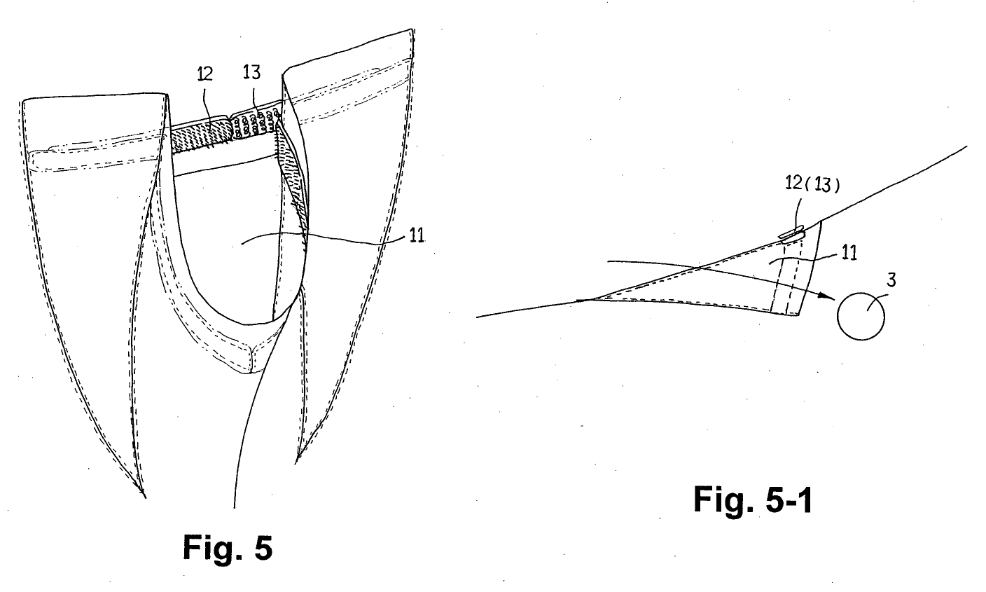

In a second preferred embodiment of the present invention as illustrated in FIGS. 4, 4-1, and 5, both sides of each course (11) are partially locked with those hooks (12) and loops (13) of the Velcro to reserve a through hole as illustrated in FIGS. 4-1 and 5-1 so that each course (11) on the concave ball rolling unit (2) is connected through to its external side for children to try throwing out the ball (3) caught in the through hole in a preset direction.

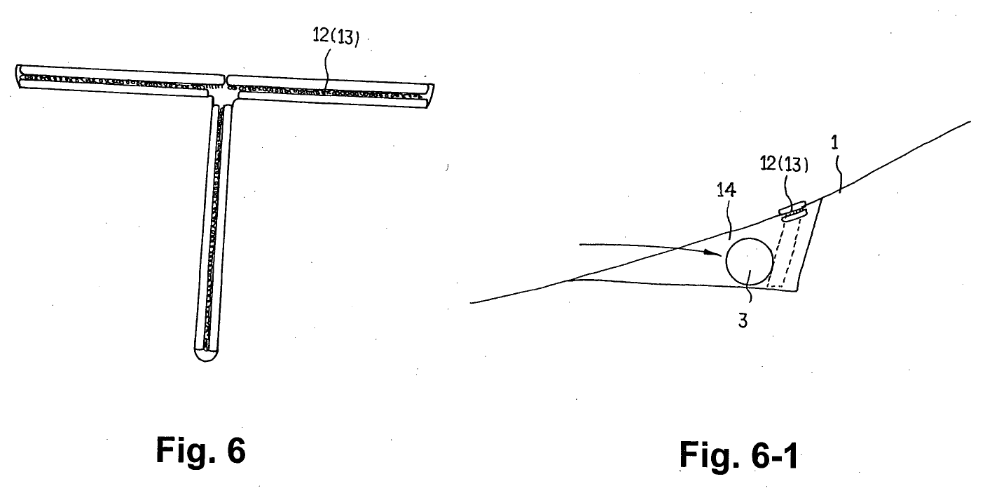

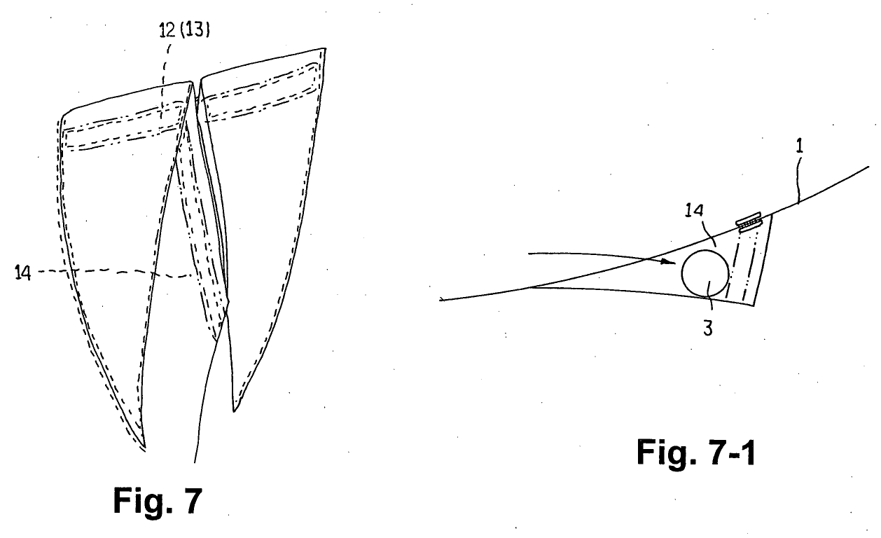

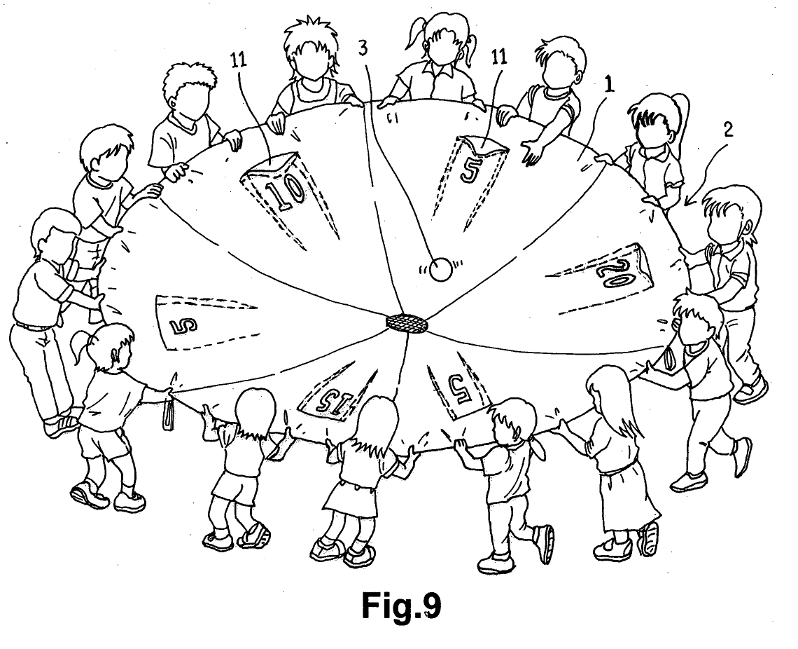

FIGS. 6, 6-1, and 7 shows a third preferred embodiment of the present invention, each course (11) on the ball rolling unit (2) is closed up with those hooks (12) and loops (13) of the Velcro sewn to the peripheral of the course (11) to form a pocket (14) as illustrated in FIG. 9 for children to try rolling the ball (3) into the pocket (14) by holding the edge of and pulling the ball rolling unit (2) up and down in a preset direction as illustrated in FIGS. 6-1 and 7-1.

Accordingly, the present invention provides the following advantages:

1. It allows variations for children to play the ball rolling game with each course opened, closed, or formed with a pocket.

2. Each pocket is externally and downward inclined so that the child is able to easily throw the ball out of the pocket.

3. Pattern or symbol may be directly printed on each course to mark winning or losing the game.

4. The symbol of each course may be distinguished from another course by color or given a serial number for scoring purpose.

What the invention claimed is:

1. A ball rolling unit for fun to initiate vision and hand coordination for pre-school children comprising multiple canopies, a section of course extending downward at a certain inclination being sewn to each canopy; an inner peripheral of each course and its corresponding sides being sewn with hooks and loops of a Velcro to open or close each course; and a ball rolling upon the ball rolling unit for pre-school children standing around the ball rolling unit to roll the ball thereon for learning to focus on movement of an object and agile reaction of their hands.

2. The ball rolling unit for fun to initiate vision and hand coordination for pre-school children as claimed in claim 1, wherein each course is closed up those pre-school children standing around the ball rolling unit to roll the ball thereon in any direction as desired by holding an edge of the ball rolling unit to pull it up and down.

3. The ball rolling unit for fun to initiate vision and hand coordination for pre-school children as claimed in claim 1, wherein each course is opened up for those pre-school children standing around the ball rolling unit to throw the ball out of the course in a preset direction by holding the edge of the ball rolling unit to pull it up and down.

4. The ball rolling unit for fun to initiate vision and hand coordination for pre-school children as claimed in claim 1, wherein each course is closed with those hooks and loops of the Velcro to form a pocket for those pre-school children standing around the ball rolling unit to roll the ball into the pocket in a preset direction by holding the edge of the ball rolling unit to pull it up and down.
